(19) United States
(12) Patent Application Publication
(10) Pub. No.: US 2019/0016617 A1
(43) Pub. Date: Jan. 17, 2019

(54) SUBMERGED MEDIA AERATED REACTOR SYSTEM AND METHOD

(71) Applicant: Environmental Dynamics International, Inc., Columbia, MO (US)

(72) Inventors: Charles E. Tharp, Columbia, MO (US); Tim Canter, Columbia, MO (US)

(21) Appl. No.: 16/034,072

(22) Filed: Jul. 12, 2018

Related U.S. Application Data
(60) Provisional application No. 62/531,700, filed on Jul. 12, 2017.

(51) Int. Cl. C02F 3/00; C02F 3/06

(52) U.S. Cl. CPC C02F 3/006; C02F 2101/16; C02F 3/06

(57) ABSTRACT

A wastewater treatment system and method are provided to nitrify and remove residual CBOD and solids from a secondary wastewater pretreatment system. The system can be configured to maintain a population of nitrifying bacteria year-round, and is therefore capable of providing a high nitrification rate during prolonged periods of cold weather.

### CROSS-REFERENCE TO RELATED APPLICATIONS

This Application claims priority to U.S. Provisional Patent Application Ser. No. 62/531,700, filed on Jul. 12, 2018, to Charles E. Tharp et al. entitled “Submerged Media Aerated Reactor System and Method,” currently pending, the entire disclosure of which is incorporated herein by reference.

### BACKGROUND OF THE INVENTION

Water and wastewater are commonly treated using a variety of techniques. Many conventional municipal and industrial wastewater treatment plants utilize lagoon technologies in treating wastewater. In many cases, these lagoon technologies are advantageous over alternative options because they require only minimal operator attention, they can be operated by a lower class operator and they require only a relatively small amount of mechanical equipment. Additionally, lagoon technologies are typically capable of minimizing sludge handling and sludge management procedures.

However, some wastewater treatment systems utilizing lagoons are not without disadvantages. For example, in many geographical locations, including the northern half of the United States, as the ambient temperature drops during the fall and winter months, the biological nitrification rate within the lagoons or other secondary biological treatment systems drops to such a low rate that not all of the nitrogen contained within the wastewater entering the lagoons or treatment plant is treated. In cold weather, the biological organisms used for treatment processes (including, for example, nitrification and carbonaceous biological oxygen demand (CBOD) reduction) in the lagoons and secondary treatment plants become less effective once the wastewater temperature drops. For example, biological reaction rates are well known to double with each 10° C. increase. Once the wastewater temperature drops to about 10° C., about 8° C., or even lower, the biological organisms are often not able to undertake nitrification and/or full CBOD removal in lagoons or treatment plants at these cooler temperatures and the treatment process has limited control that can be used to improve performance. Synthesis or growth activity of nitrification biological organisms, in particular, is minimized at these cooler temperatures. This reduction in activity can, in some cases, result in effluent leaving the wastewater treatment system with ammonia levels equal to influent and/or in excess of those permitted by applicable government regulations.

Thus, a need exists for a wastewater treatment system and method capable of utilizing and adapting existing lagoon and secondary wastewater treatment effluents such that the system is capable of maintaining a sufficient population of nitrifying bacteria and a sufficiently high rate of ammonia removal year-round, and in particular during prolonged periods of cold weather.

### SUMMARY OF THE INVENTION

One aspect of the present invention is directed generally to a biological treatment system and method that may be adapted for following conventional lagoon or secondary biological treatment systems to complete the treatment process to a high level. In particular, this treatment system is used to convert nitrogen to nitrate (i.e., to complete the nitrification of the wastewater and remove small CBOD in a polishing mode).

Provided herein is a method for treating wastewater in a wastewater treatment system, the method including the steps of measuring the ammonia content of an influent stream and, when the measured ammonia content of the influent stream falls below a first threshold value, adding supplemental ammonia to the wastewater within the system. The supplemental ammonia can be added to the wastewater at a point upstream from a reaction zone. In other embodiments, the ammonia content may measured at the effluent stream. The method can also include the steps of measuring the ammonia content of the effluent stream and, when the measured ammonia content of the influent stream exceeds a second threshold value, adding a supplemental population of nitrifying bacteria to the reaction zone.

Also provided herein is a method for treating wastewater in a wastewater treatment system, the method including at least first and second modes of operation. The method comprises a step of providing a wastewater treatment system having a first reaction zone with a first population of nitrifying bacteria, and a second reaction zone with a second population of nitrifying bacteria; a first outlet through which treated wastewater exits the first reaction zone, and a second outlet through which treated wastewater exits the second reaction zone; and a wastewater inlet positioned upstream from (or located between) the first and second reaction zones. In other words, in one embodiment, the system comprises one inlet and two outlets. The method further comprises a step of supplying wastewater to the system. During the first mode of operation, the flow of the wastewater may be controlled through the system such that the wastewater predominately flows through the first reaction zone and exits through the first outlet. During the second mode of operation, the flow of the wastewater may be controlled through the system such that the wastewater predominately flows through the second reaction zone and exits through the second outlet. The first and second modes of operation may be undertaken during warm weather months. During a third mode of operation, the flow of wastewater may be controlled through the system such that the wastewater flows through both the first and second reaction zones and exits through both the first and second outlets. The flow through the first and second outlets can be controlled by the adjustment of control mechanism in the effluent control structure, as generally described herein. Typically, the flow through the first and second outlets is approximately equal during the third mode of operation. The third mode of operation may be undertaken during cold weather months as a preferred operating mode.

Further provided herein is a wastewater treatment system comprising a first reaction zone having a first population of nitrifying bacteria, and a second reaction zone having a second population of nitrifying bacteria; a first outlet through which treated wastewater exits the first reaction zone, and a second outlet through which treated wastewater exits the second reaction zone; and a wastewater inlet positioned upstream from (or located between) the first and second reaction zones. Again, in one embodiment, the system comprises one inlet and two outlets. As discussed above, the system is configurable for a first mode of operation and a second mode of operation, such that during the first mode of operation, the wastewater predominately flows through the first reaction zone and exits through the first outlet; and during the second mode of operation, the wastewater predominately flows through the second reaction zone and exits through the second outlet. The system is also configurable for a third mode of operation wherein the water flows through both the first and second reaction zones and exits through both the first and second outlets.

It will be appreciated that the first and second reaction zones may be located within a single reactor. In such a case, the inlet can be located in an upper central portion of the reactor, the first outlet can be located in a lower region of the reactor proximate a first side, and the second outlet can be located in a lower region of the reactor proximate a second side.

Furthermore, the wastewater treatment system may include an internal recirculation system for recirculating wastewater within a single reactor system. In general, the recirculation system can include an intake located in a lower region of the reactor and an exit or distribution point located in an upper region of the reactor. In one embodiment, the recirculation system includes (a) a horizontal longitudinal intake or return pipe in a lower region of the reactor proximate an outlet, (b) a vertical lift pipe which may be located within a manhole, and (c) a horizontal longitudinal exit or distribution pipe in an upper central region of the reactor proximate the inlet.

Other objects and features will be in part apparent and in part pointed out hereinafter.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views;

FIG. 1 is a schematic end view of a wastewater treatment system in accordance with one embodiment of the present invention;

FIG. 2 is a schematic end sectional view of a single reactor wastewater treatment system in accordance with one embodiment of the present invention, illustrating manholes and recirculation systems associated with each of the first and second reaction zones;

FIG. 3A is a schematic diagram of a wastewater treatment system in accordance with one embodiment of the present invention, illustrating the system operating in a first configuration or mode that pre-conditions the reactor for subsequent cold weather operation;

FIG. 3B is a schematic diagram of a wastewater treatment system in accordance with one embodiment of the present invention, illustrating the system operating in a second configuration or mode that pre-conditions the reactor for subsequent cold weather operation;

FIG. 3C is a schematic diagram of a wastewater treatment system in accordance with one embodiment of the present invention, illustrating the system operating in a third configuration or mode that represents typical operating conditions during cold weather operation;

FIG. 4A is a schematic diagram illustrating a wastewater treatment system operating in its first configuration or mode corresponding generally with that illustrated in FIG. 3A;

FIG. 4B is a schematic diagram illustrating a wastewater treatment system operating in its second configuration or mode corresponding generally with that illustrated in FIG. 3B;

FIG. 4C is a schematic diagram illustrating a wastewater treatment system operating in a third configuration or mode corresponding generally with that illustrated in FIG. 3C;

FIG. 5A includes a partial end sectional view of a single reactor wastewater treatment system in accordance with one embodiment of the present invention, illustrating a manhole and recirculation system associated with each of the first and second reaction zones;

FIG. 5B is a partial top schematic view of the single reactor wastewater treatment system illustrated in FIG. 5A;

FIG. 6 is a top schematic plan view of a wastewater treatment system in accordance with a typical embodiment of the present invention, the system including two separate reactors arranged in parallel;

FIG. 7 is an end sectional view of a single reactor wastewater treatment system taken along line A as indicated in FIG. 6;

FIG. 8 is a top layered sectional view of a single reactor wastewater treatment system in accordance with an embodiment of the present invention;

FIG. 9 is a perspective view of a single reactor wastewater treatment system in accordance with an embodiment of the present invention, having portions thereof cutaway to illustrate various components;

FIG. 10 is a schematic diagram of a wastewater treatment system in accordance with a further embodiment of the present invention that includes a recirculation system as described herein;

FIG. 11A is a schematic diagram of a wastewater treatment system in accordance with a further embodiment of the present invention, which includes first and second recirculation systems that may be configured independently from one another;

FIG. 11B is a schematic diagram of a wastewater treatment system in accordance with an embodiment of the present invention generally corresponding to FIG. 11A, but wherein the reactor effluent streams are located proximate to the reactor inlet stream;

FIG. 12A depicts a cross-sectional view of a reactor having a “center feed” configuration, with a first outlet proximate to a first side of the reactor, a second outlet proximate to a second side of the reactor, and an inlet approximately centered between the two outlets; and

FIG. 12B depicts a cross-sectional view of a reactor having an “end feed” configuration, with an inlet proximate to a first side of the reactor and an outlet proximate to the second side of the reactor.

### DESCRIPTION OF THE PREFERRED EMBODIMENTS

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention as defined by the appended claims and the description is, therefore, not to be taken in a limiting sense and shall not limit the scope of equivalents to which such claims are entitled.

The present disclosure relates generally to the field of treatment of wastewater, and more particularly to an improved system and method for treating wastewater containing contaminants. The system and method can be advantageously employed to reduce the ammonia content of treated or effluent wastewater. In particular, the system and method may be employed to provide a sufficient population of nitrifying bacteria and a sufficiently high rate of ammonia removal year-round, specifically during periods of prolonged cold weather. The embodiments described herein may be implemented in new wastewater treatment systems and structures, or may be implemented to upgrade existing systems and structures.

The wastewater treatment system provided herein may comprise a plurality of reaction zones wherein ammonia is oxidized to nitrate. For example, in one embodiment, the system comprises at least a first reaction zone having a first population of nitrifying bacteria, and a second reaction zone having a second population of nitrifying bacteria. It is noted that genera of nitrifying bacteria suitable for use in wastewater treatment systems are well known within the art. Generally, the term “nitrifying bacteria” as used herein refers to bacteria capable of oxidizing ammonia to nitrate.

The system comprises a wastewater inlet through which an influent stream having a generally high ammonia content (for example, an ammonia content of about 10 mg/L or greater) enters the system. The influent stream may be, for example, an effluent from a standard municipal treatment lagoon or effluent from a secondary biological treatment plant. For instance, the influent stream may be an effluent from a treatment lagoon comprising a population of heterotrophic bacteria. Alternatively, the influent stream may be effluent from a conventional activated sludge or other secondary treatment process. More generally, the influent stream may be any source of properly pretreated wastewater having a high ammonia content, or more generally an ammonia content requiring reduction prior to discharge from the total treatment process.

In one embodiment, the system includes one inlet and two outlets. As such, the system may comprise a first outlet through which treated wastewater exits the first reaction zone, and a second outlet through which treated wastewater exits the second reaction zone. Preferably, each effluent stream exiting the wastewater treatment system has a lower ammonia content than the influent stream entering the wastewater inlet.

Generally, the plurality of reaction zones may be spatially oriented in any configuration. For example, the first reaction zone and the second reaction zone may be located within a single reactor. In this configuration, the first reaction zone may be defined as the area of the reactor that is proximate to the first outlet, while the second reaction zone may be defined as the area of the reactor that is proximate to the second outlet. Optionally, a wall may separate the first reaction zone from the second reaction zone. Alternatively, the system may comprise a first reactor forming a first reaction zone and a second reactor forming a second reaction zone.

Typically, when the first reaction zone and the second reaction zone are located within a single reactor, the wastewater inlet is located within the reactor in an intermediate position between the first and second reaction zones. In a preferred configuration, the first outlet is located within the first reaction zone in a location distal from the wastewater inlet, and the second outlet is located within the second reaction zone in a location distal from the wastewater inlet and opposite from the first outlet.

To promote the flow of wastewater throughout the entire volume of the reactor, the wastewater inlet and outlets may be located at different vertical locations within the reactor. For example, in one embodiment, the wastewater inlet is located proximate to the top of the reactor, and some or all of the outlets are located proximate to the bottom of the reactor. Alternatively, in another embodiment, the wastewater inlet is located proximate to the bottom of the reactor, and some or all of the outlets are located proximate to the top of the reactor.

Like many biological processes, the rate at which nitrifying bacteria process ammonia is strongly temperature dependent. As a consequence, during periods of cold weather, the ability of a given population of nitrifying bacteria to remove ammonia from the wastewater to be treated decreases significantly. The present disclosure addresses this problem by maintaining multiple large populations of attached and suspended nitrifying bacteria within the system. During periods of warm weather, when the activity of the nitrifying bacteria is high, the population within any single zone may be capable of fully treating the incoming wastewater and producing an effluent stream having an acceptably low ammonia content. Conversely, during periods of prolonged cold weather when no single population of nitrifying bacteria would be capable of fully treating the incoming wastewater, the system can be configured to utilize each of the plurality of reaction zones in parallel. The system thus allows for acceptable removal of ammonia from incoming wastewater even during the winter months.

Accordingly, the systems described herein may be capable of being configured to control the rate at which wastewater flows through each reaction zone. For example, the wastewater treatment system may comprise a flow control or diverter that can be configured to control the amount of incoming wastewater that is directed to each reaction zone. The flow control or diverter can comprise, for example, a flow splitter, splitter box, and/or a pump station.

Alternatively, the flow through each reaction zone may be controlled by configuring the outlet(s) for each reaction zone. For example, if the first outlet is closed or otherwise deactivated, the flow of wastewater entering the system will be directed primarily through the second reaction zone, and the wastewater will exit the system only through the second outlet. Likewise, if the second outlet is closed or otherwise deactivated, the flow of wastewater entering the system will be directed primarily through the first reaction zone, and the wastewater will exit the system only through the first outlet. In some embodiments, the flow through each reaction zone can be controlled by configuring both the wastewater inlet and by activating or deactivating the outlet(s) for each reaction zone as appropriate to obtain the desired flow configuration.

The system preferably comprises, within one or more of the reaction zones, submerged media that promote the growth and accumulation of microbes and/or complex biomass thereon (attached growth) while allowing flow of wastewater through the media. In a preferred embodiment, the submerged media permit substantially saturated flow therethrough. In general, the submerged media may comprise rigid or fixed media, flexible media, or a combination thereof. The submerged media, whether rigid or flexible, should provide a material and surface area suitable for effectively promoting the accumulation and growth of microbes thereon in a sufficient quantity to create an environment for treating the wastewater or other liquid that is undergoing treatment. When the submerged media includes rigid media, it may be in the form of film, sheets, disks, blocks, matrices or honeycombs and may be made of polythene, polyvinyl chloride (PVC), expanded polystyrene, gravel, natural or synthetic materials, as well as a wide variety of other materials. In one embodiment, the submerged media is gravel is generally uniform in size and round in order to maximize pore volumes. Preferably, the gravel has minimal iron or limestone content and is devoid of fines. When the bio media or submerged media includes flexible media, it may be in the form of film, sheets or clusters of strips such as described in U.S. Pat. No. 7,713,415 to Tharp, et al. and marketed by Environmental Dynamics International, Inc. (“EDI”) under the BIOREEF® or BIOCURTAIN™ names. The entire disclosure of U.S. Pat. No. 7,713,415 to Tharp, et al. is hereby incorporated by reference. Alternatively, the bio media or submerged media may include soft contact media having a high surface area, such as those described in U.S. Pat. No. 8,163,174 to Lin, the entire disclosure of which is hereby incorporated by reference.

The system may further comprise a means or system for recirculating the wastewater within the single reactor system. For example, one or more of the reaction zones may comprise a recirculation intake. Wastewater that enters the recirculation intake is transported to another location within the wastewater treatment system. For example, in one embodiment, the recirculation intake is located proximate to the bottom of the reactor, and is transported to a location proximate to the top of the reactor (e.g., via an airlift) where it exits the recirculation system and complements the inlet flow of untreated wastewater.

In other embodiments, the recirculation system may be configured such that a portion of the treated wastewater exiting the reaction zone(s) is directed into the recirculation system and subsequently re-enters the reaction zone(s). For example, the recirculation system may be configured such that at least about 50%, at least about 60%, at least about 70%, at least about 80%, at least about 90%, or even at least about 95% exiting the reaction zone(s) is directed into the recirculation system, with the remaining portion of the treated wastewater exiting the system as effluent.

The use of internal liquid recirculation provides several advantages in the context of a wastewater treatment system. First, internal recirculation can help reduce or prevent the buildup of solids near the wastewater inlet. For example, under operating conditions where the flow rate through the wastewater inlet is relatively low, solids in the incoming wastewater stream will have a tendency to accumulate on the submerged media near the inlet, which can potentially result in blinding, blockages and/or flooding. This problem can be reduced or avoided through use of an internal recirculation system. More specifically, when liquid exits the recirculation system through or near the wastewater inlet, the liquid flow velocity in that region is increased as a result of the greater combined liquid flow rate. The higher flow velocity, in turn, helps carry solids further into the reaction zones, utilizing a greater portion of the reactor and reducing the rate at which solids accumulate on the submerged media near the inlet.

Second, the use of internal liquid recirculation enhances O₂ transfer within the treatment system. For example, the air lift action in the manholes, plus the recirculation created by the air lift, may be used to move wastewater from a point near the exit of a reaction zone, into a recirculation pit, and then back into the top portion of the reactor. When internal liquid recirculation is utilized, water circulates over the aeration system more frequently, with a greater proportion of low dissolved oxygen water reaching the aeration diffusers. It also allows the aeration diffusers to be placed farther apart, as the recirculation pulls the water across the diffusers to more completely utilize the full extent of the reactor.

Third, the use of internal liquid recirculation enhances the field wastewater velocity to utilize the entire reactor. Specifically, recirculation can be used to avoid a flow pattern where all the water enters the reactor at the top, and runs in a straight path directly to the outlet. Recirculation can be advantageously employed to utilize the areas of the reactor that fall outside a straight line hydraulic gradient from the inlet to the outlet (e.g., a large portion of the reactor volume).

Fourth, the manholes required to access the recirculation system also provide sampling ports that are useful for monitoring overall system performance at different locations within the reactor. This allows an operator to more easily monitor the state of the treatment system, and in particular to confirm that the entire volume of the reactor is being successfully utilized.

Fifth, the use of internal liquid recirculation helps distribute the ammonia content and/or bacteria more evenly throughout the entire reactor volume. This, in turn, helps maintain a larger biomass population that is more evenly distributed throughout the reactor. For example, in some embodiments, the biomass population is distributed on a substantially uniform basis throughout the submerged media volume of the reactor.

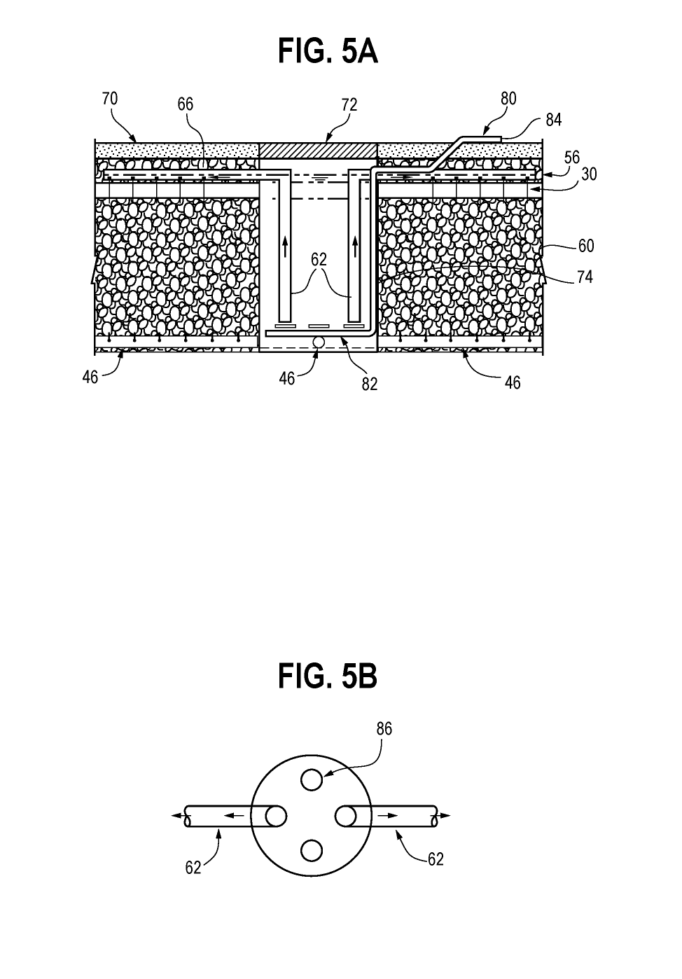

In preferred embodiments, the recirculation system utilizes manholes that are from about 12″ to about 14″ in diameter. The use of relatively small manholes is advantageous because it minimizes the usage of reactor space that could otherwise be filled with submerged media. Smaller manholes are also easier to cover structurally, while providing an easy and effective means for performing maintenance on the recirculation system. For example, in the wastewater treatment system shown in schematic FIG. 5A, the recycle piping is advantageously composed of a 12″ diameter pipe with 2″ to 4″ airlifts.

The system preferably further comprises an aeration system that provides an oxygen source (e.g., air) to one or more of the reaction zones. Suitable aeration systems are generally known in the art, including those marketed by EDI. Generally, fixed grid aeration, submerged laterals, or other types of aeration systems can be used, including either fine or coarse bubble aeration or a combination of fine and coarse bubbles. In addition, both coarse and fine bubble aerators are known to operate efficiently for mixing and transfer of air to the wastewater that is undergoing treatment.

The system may further comprise a means or system for insulating one or more of the reaction zones. For example, one or more of the reaction zones may be insulated using an insulating layer or cover having a high thermal resistance including an encapsulated from insulating cover, or adequate layers of organic mulch. A permeable liner or other sheet of material may be placed between the media bed and the insulating layer, the liner being suitable for permitting water to infiltrate into the media bed, but at the same time blocking or otherwise preventing plant roots and smaller particles from entering the media bed.

The system may further comprise a means or system for measuring and/or controlling the level of ammonia present in the wastewater entering the reactor. Typically, the incoming stream of wastewater to be treated comprises the effluent from a pretreatment system or lagoon. The amount of ammonia present in this incoming wastewater stream may vary over time due to a number of factors, and particularly in response to seasonal variations in temperature. For example, during warm weather months, the ammonia concentration in the wastewater entering the system (e.g., the wastewater exiting the upstream lagoon or pretreatment system) may become very low. If there is insufficient ammonia present to support the entire population of nitrifying bacteria present in the reactor, the population will shrink, resulting in a reactor having a reduced treatment capacity once the ammonia level s increase during cooler months.

To address this problem, the wastewater treatment system may comprise an ammonia control system, whereby ammonia can be added to the wastewater present within the system. The decision to add ammonia to the system may be based on a number of factors, including but not limited to measurements of the ammonia content in the wastewater entering the system; the temperature of the wastewater entering the system; or the ammonia may be added on a fixed, periodic basis (e.g., during a specified portion of the year). For example, the wastewater treatment system may comprise a means or system for adding ammonia to the wastewater within the system when the measured ammonia content of the incoming wastewater stream drops below a specified threshold value. In preferred embodiments, the ammonia is added to the wastewater stream entering the reactor and/or to the influent equalization structure (if present).

The system may further comprise a means or system for supplementing the population of nitrifying bacteria present in the reactor. As discussed above, the amount of ammonia present in the incoming wastewater stream may vary over time due to a number of factors, and particularly in response to seasonal variations in temperature. During cold weather months, the ammonia concentration in the wastewater entering the system (e.g., the wastewater exiting the upstream lagoon or pretreatment system) may become very high. If the population of nitrifying bacteria present in the reactor is of insufficient size, the effluent from the system may contain an impermissibly high ammonia content (i.e., an ammonia content exceeding an amount permissible under government or other regulatory standards or laws). To address this problem, the wastewater treatment system may comprise a bioaugmentation system, whereby a supplemental population of nitrifying bacteria can be added to the system. The decision to add supplemental bacteria to the system may be based on a number of factors, including but not limited to measurements of the ammonia content in the wastewater entering and/or exiting the system; the temperature of the wastewater entering the system; or supplemental bacteria may be added on a fixed, periodic basis (e.g., during a specified portion of the warm weather months). For example, the wastewater treatment system may comprise a means or system for adding supplemental bacteria to the system when the measured ammonia content of the system's effluent stream rises above a specified threshold value.

Particularly preferred embodiments of the wastewater treatment system will comprise both an ammonia control system and a bioaugmentation system as described above.

As a non-limiting example, an embodiment of a wastewater treatment system as described herein may be operated as follows. During the summer months, the ammonia content of the incoming wastewater stream (e.g., from an upstream lagoon or pretreatment basin) is monitored. If the ammonia content drops below a predetermined threshold value, supplemental ammonia is released at a controlled rate into the wastewater within the system, preferably at a point upstream of the reaction zone(s). This allows a large population of nitrifying bacteria to be maintained, even when there would otherwise be insufficient ammonia present in the incoming wastewater to sustain a population of that size. When combined with a recirculation system that distributes the ammonia substantially evenly throughout the reactor volume, a large population of nitrifying bacteria can be maintained within the reaction zone(s) even during the summer months. During the fall months, the ammonia levels in the incoming wastewater stream will naturally begin to rise, and monitoring can be used to correspondingly reduce, and eventually stop, the addition of supplemental ammonia to the system. During the winter months, it becomes more important to monitor the ammonia content in the effluent stream exiting the system. If the ammonia content of the system's effluent stream rises above a predetermined threshold value, thereby indicating that the population of nitrifying bacteria in the reaction zone(s) is insufficient to fully treat the incoming wastewater, bioaugmentation can be used to introduce supplemental population(s) of nitrifying bacteria into the system until the ammonia content of the effluent stream falls to within the desired range. Finally, during the spring months, the ammonia content of the outgoing and incoming wastewater streams can be monitored to determine the need to (a) reduce, and eventually stop, the addition of supplemental nitrifying organisms, and (b) if necessary, begin adding supplemental ammonia to the system.

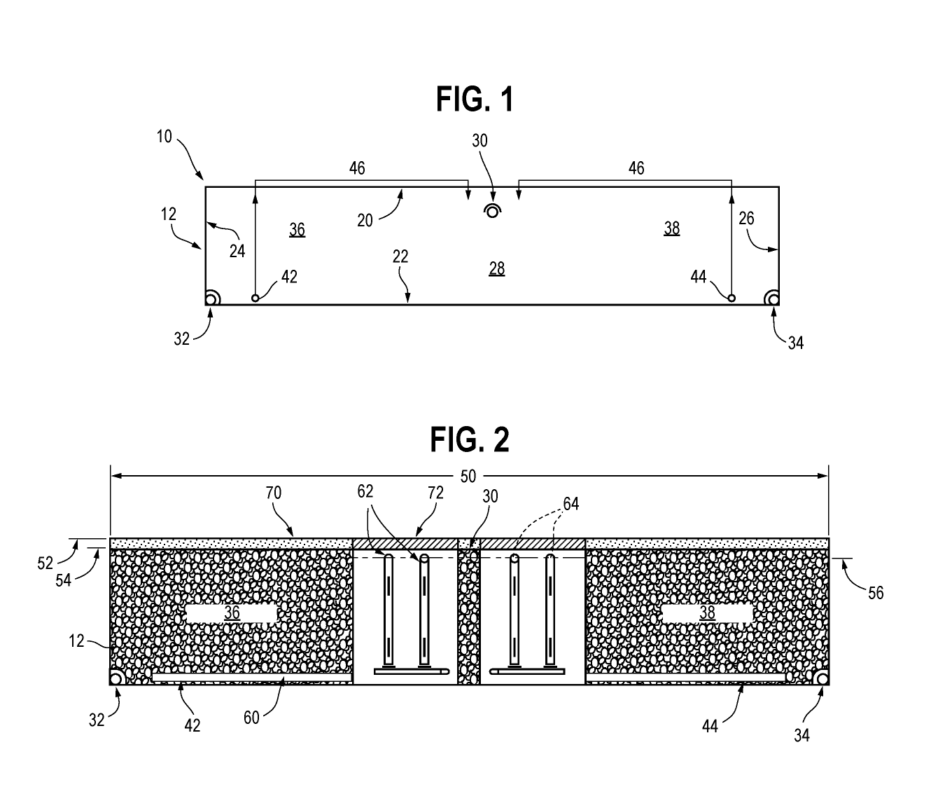

Referring now to the drawings and initially to FIG. 1, numeral 10 generally designates a wastewater treatment system that includes, among other things, a reactor 12 for containing and treating wastewater. The reactor 12 may take the form of a lagoon, basin, tank or other containment vessel. The reactor 12 may be constructed of concrete, earth, metal, plastic, natural or synthetic lining materials or combinations thereof.

As shown, the reactor 12 includes a central inlet area 20, a bottom or floor 22, a first sidewall 24, and a second sidewall 26. Though not illustrated, the reactor 12 can optionally comprise outwardly sloping sidewalls 24 and 26.

The reactor 12 further comprises an inlet 30, a first outlet 32, and a second outlet 34. The portion of the reactor proximate to the first outlet 32 defines a first reaction zone 36, and the portion of the reactor proximate to the second outlet 34 defines a second reaction zone 38.

As discussed above, the reactor 12 may further comprise an internal recirculation system for recirculating wastewater within the reactor 12. In general, the recirculation system can include an intake located in a lower region of the reactor and an exit or distribution point located in an upper region of the reactor. In one embodiment, the recirculation system includes (a) one or more horizontal longitudinal intake or return pipes 42 and 44 in a lower region of the reactor proximate an outlet, (b) one or more vertical lift pipes 62 and 64 which may be located within a manhole, and (c) one or more horizontal longitudinal exit or distribution pipes in an upper region of the reactor proximate the inlet 30. As depicted schematically in FIG. 1, the reactor 12 comprises first and second recirculation intakes 42 and 44. Wastewater that enters recirculation intakes 42 and 44 is transported through recirculation return piping 46 and reenters the reactor proximate inlet 30.

A section view of the wastewater treatment system is depicted in FIG. 2. The reactor 12 has a total width 50 and a total height 52. The reactor comprises submerged media 60, which fill the space within the reactor to a height 54, and may be filled with wastewater to a height 56. In this embodiment, wastewater that enters the recirculation system via recirculation intakes 42 and 44 is emitted through recirculation air lifts 62 and 64 at a point near the top of the media.

Since the system is designed to nitrify during cold weather months, an insulating layer 70 or cover can be provided at the top of the reactor 12 to retain heat which enables nitrification to occur in cold wastewater temperatures. The insulating layer 70 may be any suitable cover or insulating layer including systems marketed by EDI under the BIOINSULATE™ name that may include insulating foam panels encapsulated in high density polyethylene (HDPE) to protect the panels. In addition or alternatively, a secondary non-woven protective fabric layer can be installed over the aggregate to keep the rock bed from blinding or clogging due to organic particulates decomposing and filling void spaces, and to prevent plant roots from entering the rock bed. This allows an alternate method of insulation via a heavy layer of protective mulch, peat moss, wood chips or other organic insulating material to be layered on top of the fabric. An insulated manhole access 72 can provide access to the recirculation airlifts for maintenance purposes.

During typical operation, the influent to be treated (e.g., wastewater) enters the reactor 12 through the inlet 30, and exits through each of the first outlet 32 and the second outlet 34. The first reaction zone 36 and the second reaction zone 38 will experience approximately equivalent wastewater flow conditions.

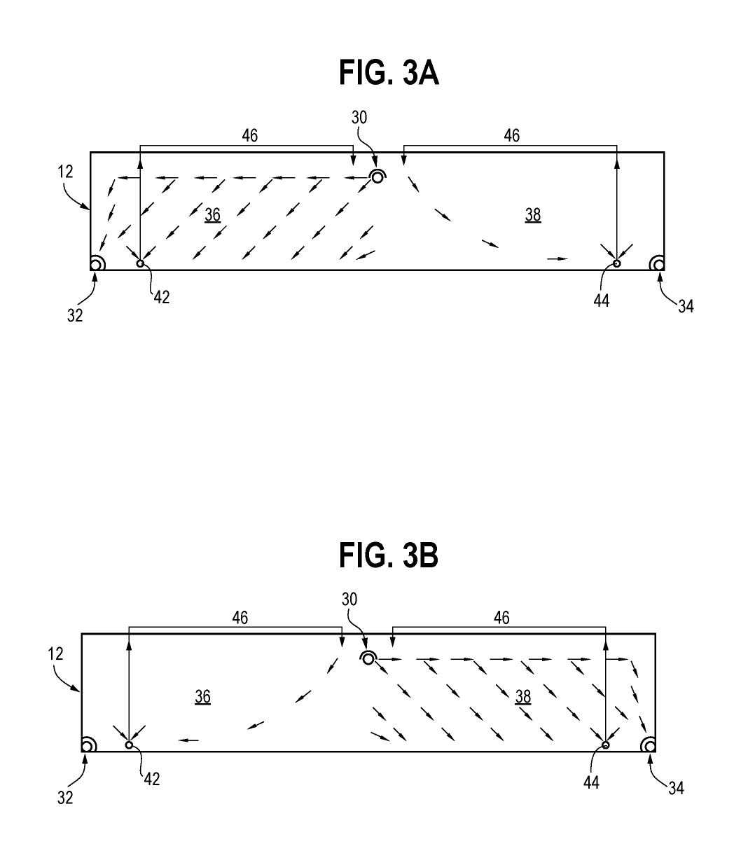

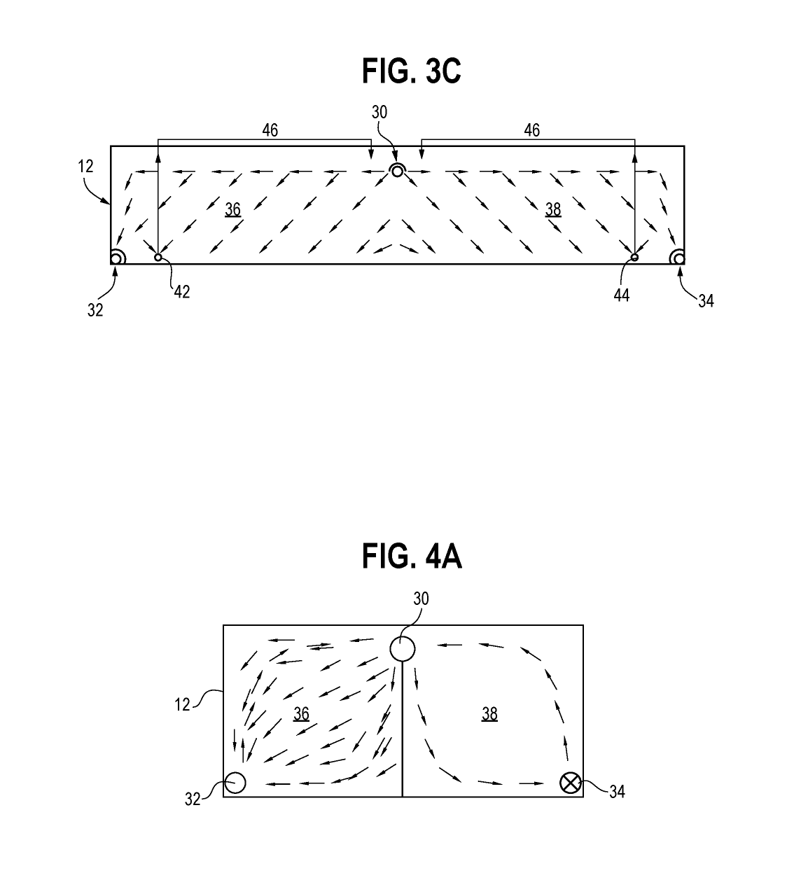

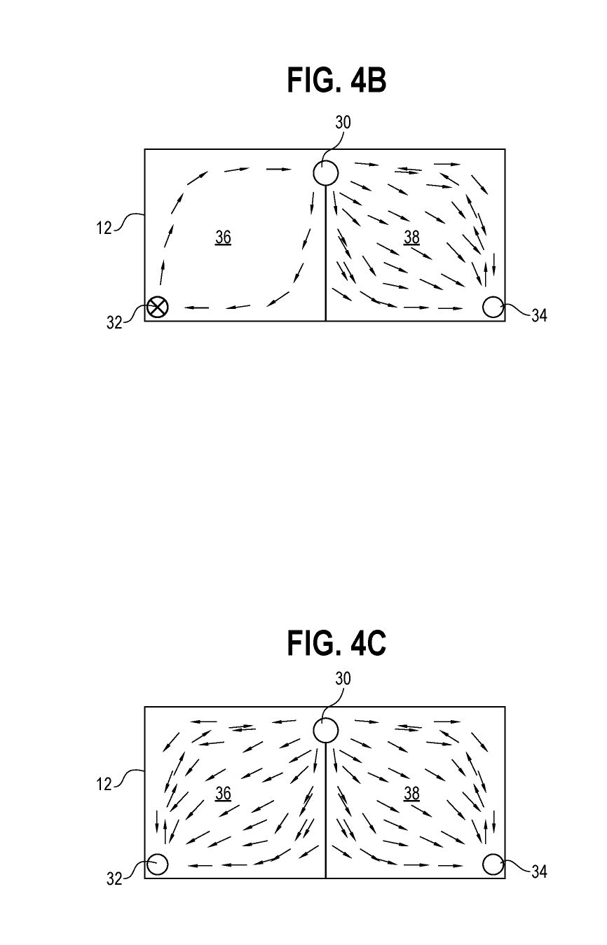

A first configuration or mode of the wastewater treatment system 10 is depicted in FIGS. 3A and 4A. In this configuration, the second outlet 34 is closed or otherwise deactivated, and wastewater exits the wastewater treatment system 10 only through the first outlet 32. As a result, wastewater flow rates through the first reaction zone 36 are significantly greater than those through the second reaction zone 38. As depicted in FIGS. 3A and 4A, the flow of wastewater through the first reaction zone 36 is generally angled. The angle of flow through the first reaction zone 36 is dependent, in part, on the height and distance of the inlet 30 relative to the first outlet 32.

A second configuration or mode of the wastewater treatment system 10 is depicted in FIGS. 3B and 4B. In this configuration, the first outlet 32 is closed or otherwise deactivated, and wastewater exits the wastewater treatment system 10 only through the second outlet 34. As a result, wastewater flow rates through the second reaction zone 38 are significantly greater than those through the first reaction zone 36. As depicted in FIGS. 3B and 4B, the flow of wastewater through the second reaction zone 38 is generally angled. The angle of flow through the second reaction zone 38 is dependent, in part, on the height and distance of the inlet 30 relative to the second outlet 34.

A third configuration or mode of the wastewater treatment system 10 is depicted in FIGS. 3C and 4C. In this configuration, both the first outlet and the second outlet are open. The wastewater flows through the first and second zones concurrently, such that the flow of wastewater through the first reaction zone is approximately equivalent to the flow of wastewater through the second reaction zone.

The varied configurations and modes described above can be used in accordance with a method of operating a wastewater treatment system that promotes a higher nitrifier organism population throughout the entire reactor with consistently high rate of nitrification rate year-round and in particular during prolonged periods of cold weather. For example, the method can comprise a pre-conditioning phase that fortifies and stabilizes the populations of bacteria in each of the reaction zones 36 and 38. During a first step or mode of the pre-conditioning phase, the system 10 is configured such that a predominate amount of the incoming wastewater flows through the first reaction zone 36 and exits through the first outlet 32. Subsequently, during a second step or mode of the pre-conditioning phase, the system 10 is configured such that a predominate amount of the incoming wastewater flows through the second reaction zone 38 and exits through the second outlet 34.

The pre-conditioning phase is typically conducted for a period of from 1 to 4 months, and shortly prior to the seasonal onset of cold weather. For example, the pre-conditioning phase may be conducted from approximately August to October.

As used herein, the term “predominate amount” means at least about 50%, for example at least about 60%, at least about 70%, at least about 80%, at least about 90%, or at least about 95%.

Without being bound to a particular theory, the first step of the pre-conditioning phase or mode promotes the growth of the first population of bacteria within and throughout the first reaction zone 36, and the second step or mode of the pre-conditioning phase promotes the growth of the second population of bacteria within and throughout the second reaction zone 38. Following the pre-conditioning phase, the wastewater treatment system 10 is better able to sustain a consistently high rate of nitrification rate throughout the cold-weather months under typical operating conditions, wherein the reaction zones 36 and 38 are utilized in parallel and each reaction zone with the enhanced bio population receives approximately an equal amount of incoming wastewater.

Accordingly, as a non-limiting example, it will be appreciated that the wastewater treatment system may transition and/or alternate between the mode of operation illustrated in FIG. 3A and the mode of operation illustrated in FIG. 3B during the pre-conditioning phase, and return to the typical mode of operation illustrated in FIG. 3C following the pre-conditioning phase.

In accordance with a preferred embodiment, FIG. 5A is a partial side sectional view that illustrates in greater detail the manhole and recirculation system associated with each of the first and second reaction zones. Manhole 74 provides access to key portions of the recirculation system and the aeration system. In the illustrated embodiment, the recirculation system includes recirculation return piping 46, which comprises a plurality of intakes through which wastewater can enter the recirculation system. The wastewater is then transported via air lifts 62 and into recycle piping 66, which comprises a plurality of outlets through which the wastewater is returned to the reaction zone. Manhole 74 also provides access to aeration rack 82, which can be used to control the rate at which air is drawn through aeration piping 80 (via air header 84) and released into the reaction zone. FIG. 5B provides a partial top sectional view of the same embodiment, including recirculation recycle piping 62 and aeration diffusers 86.

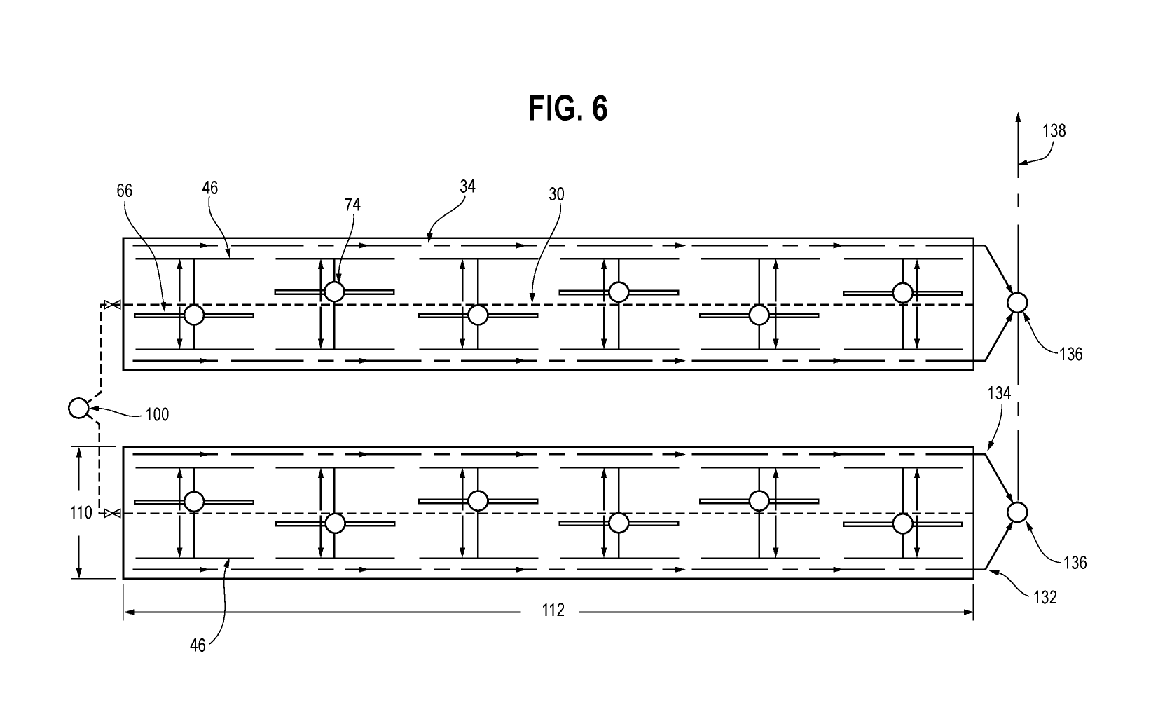

As a further illustration of a preferred embodiment, FIG. 6 provides a top schematic plan view of a wastewater treatment system including two separate reactors arranged in parallel. An influent splitter structure 100 directs portions of the incoming wastewater influent stream to one or more of the reactors arranged in parallel. Although not required, each reactor in the system will typically have the same or similar layout and dimensions, such as the reactor width 110 and reactor length 112. In accordance with the embodiments generally described above, each reactor comprises an inlet 30, a first outlet 32, and a second outlet 34. For each reactor, the effluent streams exiting through first outlet 32 and second outlet 34 are transported through effluent channels 132 and 134, respectively, and are ultimately combined in an effluent level control structure 136. A final effluent stream, drawn from the level control structure 136, is transported out of the wastewater treatment system via final effluent channel 138.

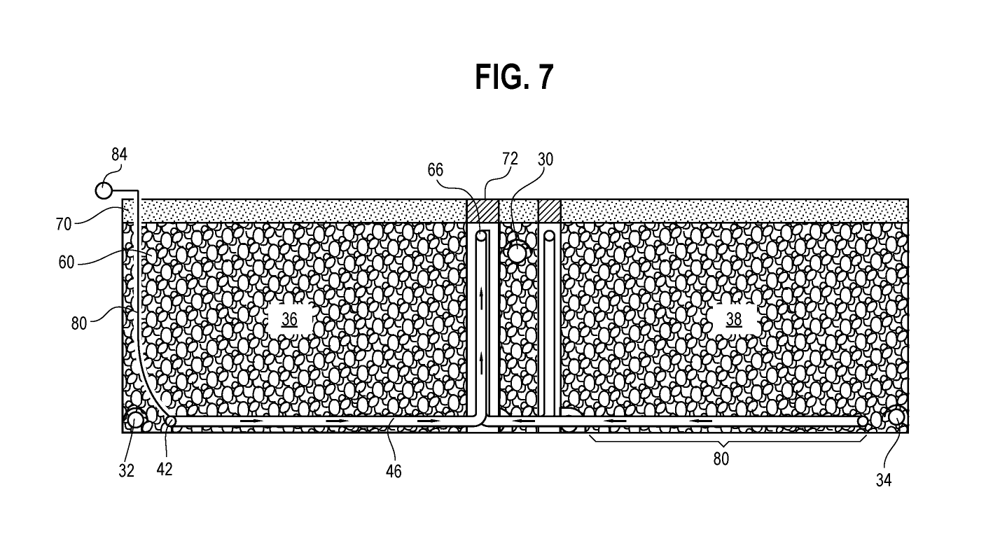

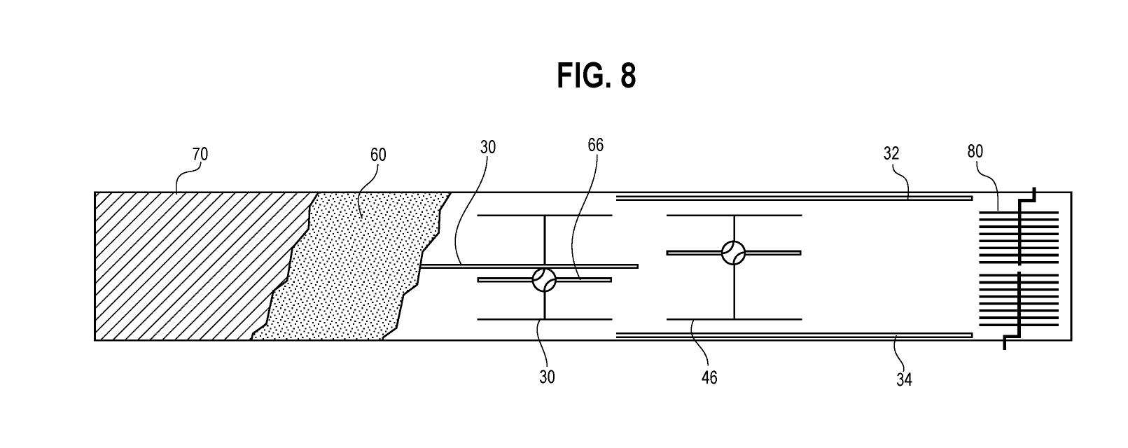

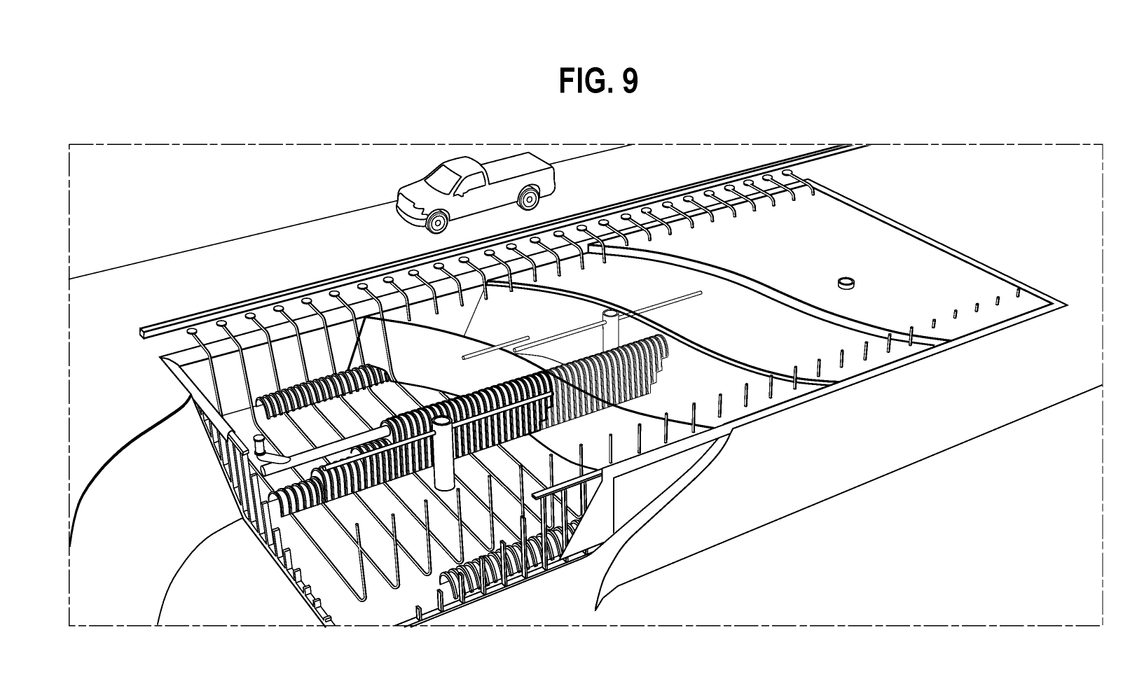

FIGS. 7 and 8 provide a further illustration of a typical embodiment of a single reactor wastewater treatment system as described above. FIG. 7 is a side sectional view of an exemplary single reactor wastewater treatment system; likewise, FIG. 8 is a top layered sectional view of an exemplary single reactor wastewater treatment system. In each figure, the illustrated wastewater treatment system comprises features and/or elements present in one or more of the exemplary embodiments described above.

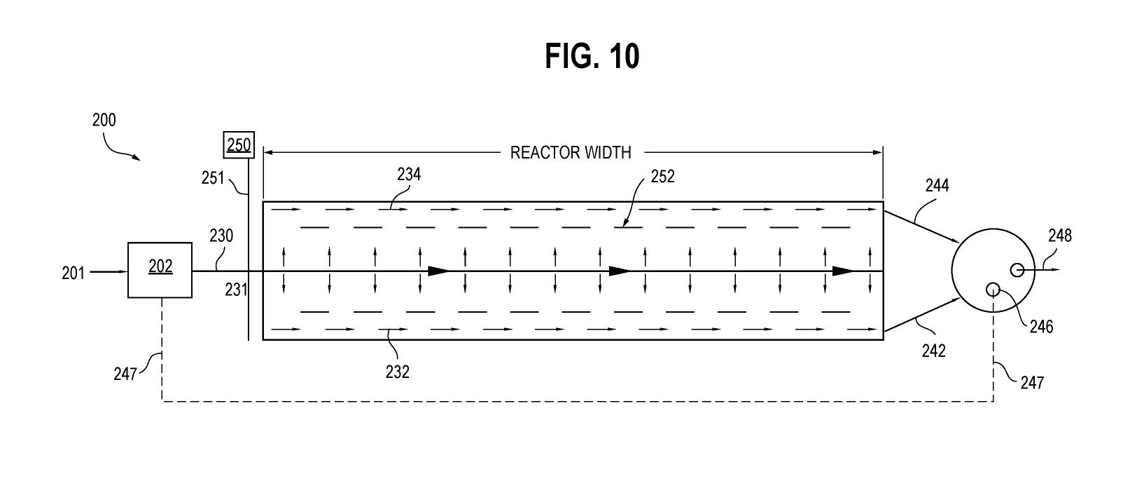

An alternative embodiment of a wastewater treatment system as generally provided herein is depicted in FIG. 10. As shown, numeral 200 generally designates a wastewater treatment system that includes, among other things, a reactor 212 for containing and treating wastewater. An incoming wastewater stream 201 (for example, influent from a lagoon or secondary pre-treatment reactor) is directed to an influent equalization chamber 202. Wastewater collected in chamber 202 is then distributed into the reactor 212 via inlet 230. In the embodiment depicted in FIG. 10, inlet 230 is positioned proximate to a center line drawn along the width of the reactor.

The reactor 212 further comprises a first outlet 232 and a second outlet 234. Wastewater that enters the reactor through inlet 230 will flow towards one of the outlets 232 or 234, as indicated by flow lines 231. The effluent streams exiting through first outlet 232 and second outlet 234 are transported through effluent channels 242 and 244, respectively, and are ultimately combined in an effluent level control structure 245.

A recycle pump 246 directs a first portion of the liquid collected in control structure 245 through recirculation piping 247, and ultimately back into influent equalization chamber 202. A second portion of the liquid collected in control structure 245 exits the system as treated effluent discharge stream 248. For example, at least about 50%, at least about 60%, at least about 70%, at least about 80%, at least about 90%, or even at least about 95% of the liquid collected in control structure 245 may be directed through recirculation piping 247.

In general, the amount of liquid recirculated through piping 247 may be held constant during operation of the wastewater treatment system, or alternatively may vary during operation of the system based upon one or more factors. For example, the system may be alternated between a first mode of operation having a first recirculation rate and a second mode of operation having a second recirculation rate, wherein the first recirculation rate is greater than the second recirculation rate. In some embodiments, the second recirculation rate may be zero (i.e., the wastewater treatment system in the second mode of operation does not utilize recirculation). In some embodiments, the system may be alternated between the first and second modes of operation on a periodic basis (e.g., the system may be configured for the first mode of operation for a fixed period of time, followed by the second mode of operation for a fixed period of time). In other embodiments, the system may be alternated between the first and second modes of operation based on other operating factors, including but not limited to the ammonia concentration found in influent stream 201 and/or influent equalization chamber 202; the temperature of water in the influent stream 201, reactor 212, or any other part of the system; and/or the time of year.

The wastewater treatment system 200 may further comprise an aeration system that can be used to increase the dissolved oxygen content of the liquid within reactor 212. As depicted, the aeration system comprises a blower 250 that directs air into air header 251. The air is then released into reactor 212 via a plurality of air diffusers 252. In general, the air flow rate through the air diffusers 252 may be may be held constant during operation of the wastewater treatment system, or alternatively may vary during operation of the system based upon one or more factors as generally described above with respect to the recirculation system. The piping or tubing supplying air to the air diffusers 252 may be a sufficient diameter and size such that it may be cleaned using internal mechanical or jetting means.

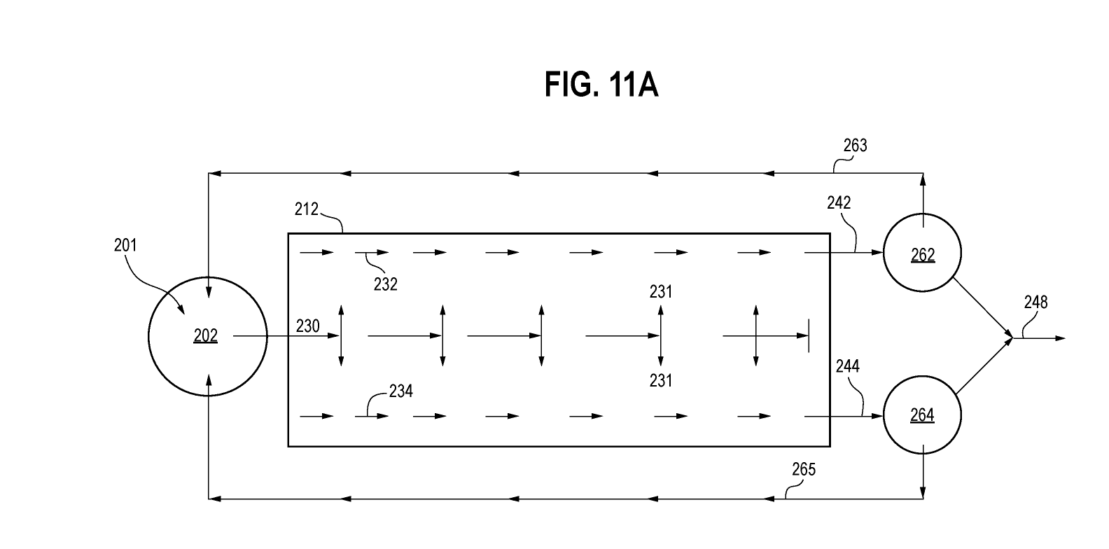

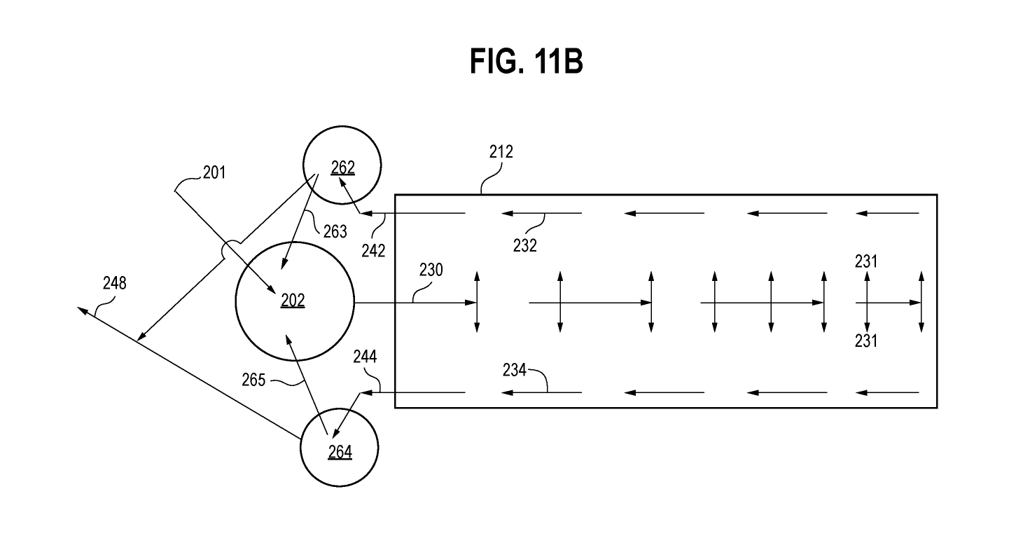

An alternative configuration or embodiment of the wastewater treatment system 200 is depicted in FIG. 11A. As shown, the effluent stream exiting through first outlet 232 is transported through effluent channel 242 and into effluent control structure 262. A first portion of the liquid collected in control structure 262 is recycled through recirculation system 263 and returned to influent equalization chamber 202. A second portion of the liquid collected in control structure 262 exits the system as treated effluent discharge stream 248. Likewise, the effluent stream exiting through second outlet 234 is transported through effluent channel 244 and into effluent control structure 264. A first portion of the liquid collected in control structure 264 is recycled through recirculation system 265 and returned to influent equalization chamber 202. A second portion of the liquid collected in control structure 262 exits the system as treated effluent discharge stream 248. The first recirculation system 263 and the second recirculation system 265 may be configured independently from one another. For example, the system may be operated in a configuration wherein the recycle flow rate through recirculation system 263 is substantially equal to the recycle flow rate through recirculation system 265. Alternatively, the system may be operated in a configuration wherein the recycle flow rate through recirculation system 263 is different from the recycle flow rate through recirculation system 265. For example, the wastewater treatment system may be operated in (1) a first mode of operation wherein the recycle flow rate through recirculation system 263 is substantially equal to the recycle flow rate through recirculation system 265; (2) a second mode of operation wherein the recycle flow rate through recirculation system 263 is greater than the recycle flow rate through recirculation system 265; and (3) a third mode of operation wherein the recycle flow rate through recirculation system 263 is less than the recycle flow rate through recirculation system 265. In some embodiments, the system may be alternated between the first, second, and/or third modes of operation on a periodic basis (e.g., the system may be configured for the first mode of operation for a fixed period of time, followed by the second mode of operation for a fixed period of time, and/or by the third mode of operation for a fixed period of time). In other embodiments, the system may be alternated between the first, second, and/or third modes of operation based on other operating factors, including but not limited to the ammonia concentration found in influent stream 201 and/or influent equalization chamber 202; the temperature of influent stream 201, reactor 212, or any other part of the system; and/or the time of year.

The configuration or embodiment of the wastewater treatment system 200 depicted in FIG. 11B generally corresponds to that depicted in FIG. 11A, except that the effluent streams 242 and 244 flow in the opposite direction and exit reactor 212 at a location proximate to influent equalization chamber 202. This configuration can be used to simplify the design of the recirculation system, but is otherwise functionally equivalent to the configuration depicted in FIG. 11A.

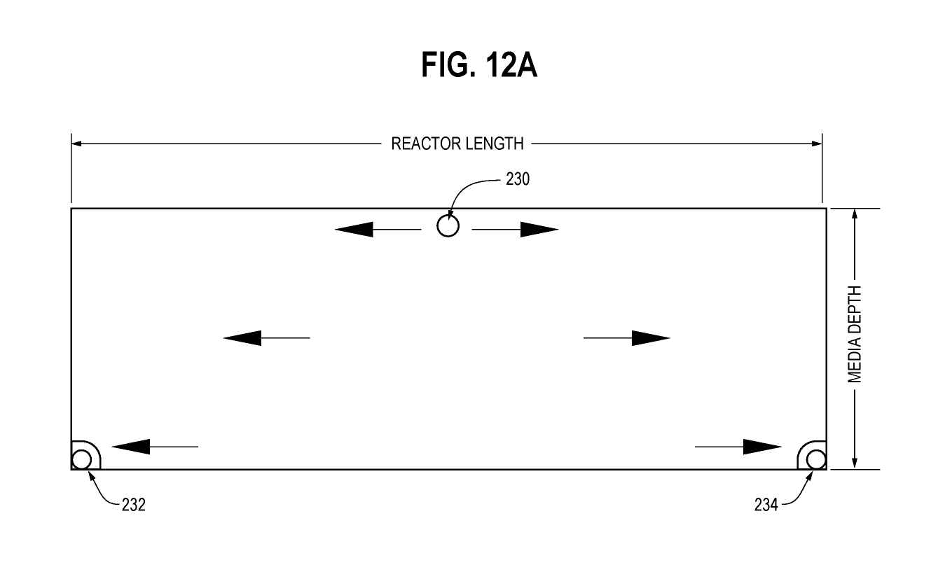

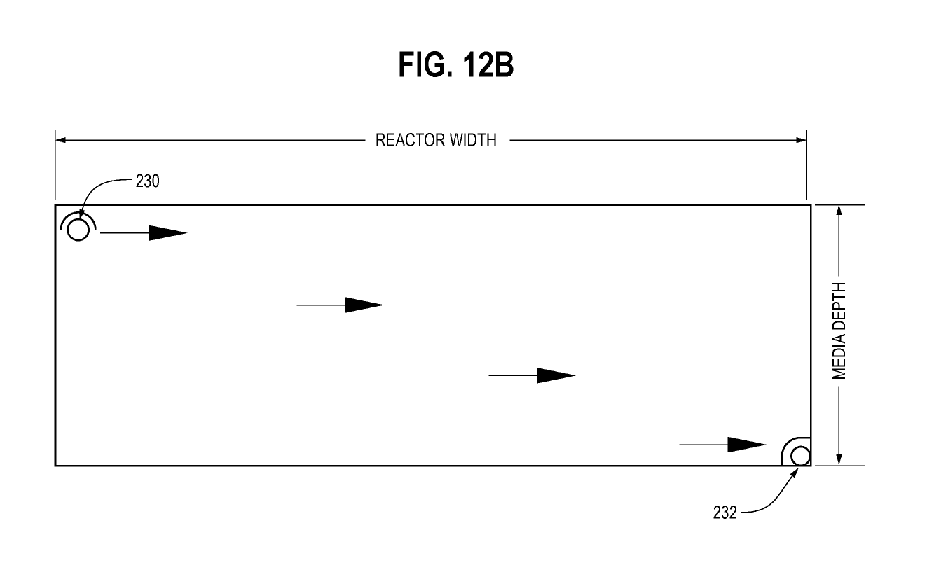

A cross-sectional view of a reactor 212 as described in the above embodiments is depicted in FIG. 12A. These embodiments may be referred to herein as having a “center feed” configuration, wherein the reactor comprises a first outlet 232 proximate to a first side of the reactor, a second outlet 234 proximate to a second side of the reactor, and an inlet 230 proximate to the center line drawn across the width of the reactor. An alternative configuration, known as an “end feed” configuration, is depicted in FIG. 12B. In this configuration, the reactor comprises an inlet 230 proximate to a first side of the reactor and an outlet 232 proximate to the second side of the reactor. In general, any embodiment of a wastewater treatment system described herein may be configured to utilize either a center feed configuration or an end feed configuration. The factors that may favor an end feed configuration relative to a center feed configuration, in a particular implementation, will be understood by those skilled in the art, and include the size and shape of the physical space available for the reactor, the amount of wastewater to be treated, and the climate of the location in which the wastewater treatment system is to be installed, among other considerations.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive, are used in the sense of “optional” or “may include” and not as “required,” and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for treating wastewater in a wastewater treatment system including an influent stream and an effluent stream, the method comprising the steps of:
providing a wastewater treatment system comprising:
a reaction zone comprising a population of nitrifying bacteria;
a wastewater inlet through which wastewater to be treated enters the reaction zone; and
at least one outlet through which treated wastewater exits the reaction zone;
supplying wastewater to the system;
measuring the ammonia content of the influent stream; and
when the measured ammonia content of the influent stream falls below a first threshold value, adding supplemental ammonia to the wastewater within the system.

2. The method of claim 1 wherein the supplemental ammonia is added to the wastewater at a point upstream from the reaction zone.

3. The method of claim 1 further comprising the steps of:
measuring the ammonia content of the effluent stream; and
when the measured ammonia content of the effluent stream rises above a second threshold value, adding a supplemental population of nitrifying bacteria to the reaction zone.

4. The method of claim 1 wherein the wastewater treatment system comprises:
a first reaction zone including a first population of nitrifying bacteria, and a second reaction zone including a second population of nitrifying bacteria;
a first outlet through which treated wastewater exits the first reaction zone, and a second outlet through which treated wastewater exits the second reaction zone; and
a wastewater inlet positioned between the first and second reaction zones.

5. The method of claim 4 wherein the wastewater treatment system is configurable for a first mode of operation and a second mode of operation, wherein
during the first mode of operation, the system is configured such that substantially all of the wastewater exits through the first outlet, and during the second mode of operation, the system is configured such that substantially all of the wastewater exits through the second outlet.

6. The method of claim 5 wherein the wastewater treatment system is configurable for a third mode of operation wherein the wastewater exits through both the first outlet and the second outlet.

7. The method of claim 6 wherein the first and second modes of operation are undertaken during warm weather months, and the third mode of operation is undertaken during cold weather months.

8. The method of claim 1 wherein the system further comprises a recirculation system configured such that:
a first portion of the treated wastewater exiting the reaction zone is directed into the recirculation system and subsequently re-enters the reaction zone; and
a second portion of the treated wastewater exiting the reaction zone is directed into the effluent stream exiting the system.

9. The method of claim 1 wherein the recirculation system is configured such that at least about 50%, at least about 60%, at least about 70%, at least about 80%, at least about 90%, or at least about 95% of the treated wastewater exiting the reaction zone is directed into the recirculation system.

10. A wastewater treatment system comprising:
an influent stream entering the system, and an effluent stream exiting the system;
a reaction zone comprising a population of nitrifying bacteria;
a wastewater inlet through which wastewater to be treated enters the reaction zone;
at least one outlet through which treated wastewater exits the reaction zone; and
an ammonia control system;
wherein the ammonia control system comprises (1) a means for measuring the ammonia content of the influent stream, and (2) a means for adding supplemental ammonia to the wastewater within the system when the measured ammonia content of the influent stream falls below a first threshold value.

11. The wastewater treatment system of claim 10 wherein the means for adding supplemental ammonia to the wastewater is located at a point upstream from the reaction zone.

12. The wastewater treatment system of claim 10 further comprising a bioaugmentation system, wherein the bioaugmentation system comprises (1) a means for measuring the ammonia content of the effluent stream, and (2) a means for adding a supplemental population of nitrifying bacteria to the reaction zone when the measured ammonia content of the effluent stream rises above a threshold value.

13. The wastewater treatment system of claim 10 further comprising:
a first reaction zone including a first population of nitrifying bacteria, and a second reaction zone including a second population of nitrifying bacteria;
a first outlet through which treated wastewater exits the first reaction zone, and a second outlet through which treated wastewater exits the second reaction zone; and
a wastewater inlet positioned between the first and second reaction zones.

14. The wastewater treatment system of claim 10 wherein the system is configurable for a first mode of operation and a second mode of operation, wherein
during the first mode of operation, the system is configured such that substantially all of the wastewater exits through the first outlet, and during the second mode of operation, the system is configured such that substantially all of the wastewater exits through the second outlet.

15. The wastewater treatment system of claim 10 further comprising a recirculation system configured such that:
a first portion of the treated wastewater exiting the reaction zone is directed into the recirculation system and subsequently re-enters the reaction zone; and
a second portion of the treated wastewater exiting the reaction zone is directed is directed into the effluent stream exiting the system.

16. The wastewater treatment system of claim 15 wherein the recirculation system is configured such that at least about 50%, at least about 60%, at least about 70%, at least about 80%, at least about 90%, or at least about 95% of the treated wastewater exiting the reaction zone is directed into the recirculation system.

17. A method for treating wastewater in a wastewater treatment system, the method including first and second modes of operation and comprising the steps of:
providing a wastewater treatment system comprising:
a first reaction zone including a first population of nitrifying bacteria, and a second reaction zone including a second population of nitrifying bacteria;
a first outlet through which treated wastewater exits the first reaction zone, and a second outlet through which treated wastewater exits the second reaction zone; and
a wastewater inlet positioned between the first and second reaction zones;
supplying wastewater to the system;
during the first mode of operation, controlling the flow of the wastewater through the system such that the wastewater predominately flows through the first reaction zone and exits through the first outlet; and
during the second mode of operation, controlling the flow of the wastewater through the system such that the wastewater predominately flows through the second reaction zone and exits through the second outlet.
